(19) United States
(12) Patent Application Publication
(10) Pub. No.: US 2012/0112051 A1
(43) Pub. Date: May 10, 2012

(54) Atmospheric Pressure Charge-Exchange Analyte Ionization

(75) Inventor: Robert B. Cody, Portsmouth, NH (US)

(73) Assignee: JEOL USA, INC., Peabody, MA (US)

(21) Appl. No.: 11/756,977

(22) Filed: Jun. 1, 2007

(51) Int. Cl. H01J 49/26

(52) U.S. Cl. 250/282

(57) ABSTRACT

A non-radioactive atmospheric pressure method for ionization of analytes comprises creating an electrical discharge in a carrier gas thus creating metastable neutral excited-state species. The carrier gas is directed at the analytes and the analytes under conditions to suppress protonated water and water clusters.

### BACKGROUND OF THE INVENTION

1. Field of the Invention

The present invention relates to atmospheric ionization of analytes and mass spectrometric methods.

2. Description of Related Art

A method of analyte detection which is capable of detecting trace analytes on surfaces at atmospheric pressure through the use of metastable neutral excited-state species or ionized derivatives thereof is described in U.S. Pat. No. 6,949,741 entitled “Atmospheric Pressure Ion Source” and U.S. Pat. No. 7,112,785 entitled “Method for Atmospheric Pressure Analyte Ionization.” These methods enable sampling neutral analyte molecules without the restriction of relocating the analyte from the surfaces on which they are attached. For example, cocaine from cash currency and chemical/biological warfare agents from surfaces of military interest can be sampled directly and in situ without swabbing or solvent washing the surface.

This method is normally operated under conditions wherein the primary mode of ionization of the analyte is proton transfer from ionized water clusters. Under these conditions, the largest peaks in the background spectrum are water clusters [(H₂O)ₙ+H]⁺ formed by interaction of excited-state helium atoms with atmospheric moisture.

Water has a proton affinity (PA) of 691 kJ/mol. Proton transfer occurs if the analyte has a higher proton affinity than the proton affinity of water clusters according to the following chemical equation:

[(H₂O)ₙ+H]⁺+Sample->[Sample +H]⁺+nH₂O

Many compounds are ionized under these conditions. However, some compounds are not efficiently ionized (for example, alkanes) because they do not have a higher proton affinity than water or water clusters. A compound will only accept a proton if it has a higher PA than the donor.

Direct ionization of an analyte by oxygen charge-exchange ionization or chemical ionization with nitric oxide (NO⁺) has been reported, but only for ion sources operating in a vacuum or under reduced-pressure conditions. It has not been employed as a positive-ion formation mechanism for atmospheric pressure ion sources.

Fluorobenzene has been used as a dopant to promote the formation of molecular ions (M⁺) by charge exchange in atmospheric pressure photoionization (APPI) with the use of a high-intensity lamp (10 eV).

### SUMMARY OF THE INVENTION

Briefly, according to one embodiment of the present invention, there is provided a method of producing analyte, analyte fragment, and/or analyte adduct ions at atmospheric pressure for mass spectrographic analysis from specimens having a proton affinity less than the proton affinity of water and water clusters. The method comprises the steps of introducing a carrier gas at atmospheric pressure into a chamber and adding energy to the chamber creating metastable neutral excited-state species and directing the carrier gas and metastable species at atmospheric pressure into contact with the specimen to form analyte ions, analyte fragment ions, and/or analyte adduct ions under conditions that suppress the formation of protonated water clusters and promote charge-exchange ionization. The suppression of the formation of protonated water clusters enables other ionization mechanisms, such as charge exchange with oxygen chemical ionization by nitric oxide and direct Penning ionization.

The conditions for adding energy to the chamber may comprise establishing an electrical potential difference between electrodes, photo excitation, microwave excitation or dielectric barrier discharge (one or both electrodes covered with dielectric layers). The conditions are selected to create metastable neutral excited-state species of the carrier gas.

According to another embodiment of the present invention, the carrier gas and metastable species are directed from the chamber into a reactant gas at atmospheric pressure, wherein the metastable species interact with the reactant gas to produce ions of the reactant gas under conditions that suppress the formation of protonated water clusters and promote charge-exchange ionization. The carrier-gas/reactant-gas/ionized-derivative mixture is directed into contact with the specimen maintained at atmospheric pressure and near ground potential.

It is an advantage, according to the present invention, that the analyte may be gaseous or non-volatile and that the analyte may be ionized at a liquid or solid surface.

It is a further advantage, according to the present invention, that specimens with a proton affinity less than water or water clusters can be ionized.

It is a still further advantage, according to the present invention, to charge-exchange ionized specimens by charge exchange with oxygen ions [O₂^{+•}] such that the mass spectrum produced is similar to spectra produced with vacuum-based electron impact (EI) ionization.

It is a still further advantage, according to the present invention, to ionize specimens by chemical ionization with the nitric oxide ions [NO^{+•}].

According to a preferred embodiment of the present invention, there is provided a method for atmospheric pressure ionization comprising: into a atmospheric pressure chamber introducing a carrier gas between a first electrode and a counter-electrode for creating a corona or glow electric discharge in the carrier gas causing the formation of neutral excited-state metastable species, and directing the carrier gas from the chamber into a reactant gas, for example, room atmosphere, maintained at atmospheric pressure under conditions to minimize formation of protonated water clusters and to form intermediate ionized species in a mixture of the carrier gas and reactant gas and directing the mixture of carrier gas and reactant gas into contact with a specimen maintained at atmospheric pressure and near ground potential to faun analyte ions, analyte fragment ions and/or analyte adduct ions.

In an apparatus for practicing the methods disclosed herein, a first electrode and counter-electrode must be maintained at potentials sufficient to induce an electrical discharge. The counter-electrode also serves to filter ionized species formed in the discharge. The potential difference between the first electrode and counter-electrode necessary for the formation of a discharge depends on the carrier gas and the shape of the first electrode and is usually several hundreds of volts, say 400 to 1,200. The first electrode, for example, a needle electrode, may have either a positive or negative potential. The counter-electrode is normally grounded or of polarity opposite to the needle electrode. This is the case whether operating in the positive ion or negative ion mode. In the positive ion mode, a lens electrode may be between ground potential and a few hundred positive volts to filter out negative ions in the carrier gas. Also, in the negative ion mode, a lens electrode may be between ground and minus a few hundred volts to filter out positive ions in the carrier gas.

According to another embodiment of the present invention, the carrier gas may be heated prior to introduction into the discharge or thereafter to facilitate vaporization or desorption of the analyte into the gas phase from surfaces and/or fragmentation.

By atmospheric pressure in this specification and the appended claims is meant pressures near ambient pressures, say 400 to 1,400 Torr. This would include pressurized aircraft and submerged submarines. For laboratory use, typical ambient pressures may fall within the range 700 to 800 Torr. By ambient temperature in the specification and claims is meant temperatures between 0° and 50° C., i.e., temperatures that may be encountered in living and working environments.

### BRIEF DESCRIPTION OF THE DRAWINGS

Other objects and features of the invention will appear in the course of the description thereof, which follows:

FIG. 1 is a perspective view of an atmospheric pressure interface or device useful, according to the present invention;

FIG. 2 is a broken away perspective view similar to FIG. 1;

FIG. 3 is a detail from the perspective view of FIG. 2;

FIG. 4 is a schematic circuit diagram of a power supply for an atmospheric pressure device or source useful, according to the present invention;

FIGS. 5A and 5B display comparative mass spectra of background ions for atmospheric ionization with neutral excited-state species without suppression of water clusters (proton-transfer ionization) and with suppression of protonated water clusters (charge-exchange ionization);

FIGS. 6A, 6B and 6C display mass spectra of n-Hexadecane for atmospheric ionization with neutral excited-state species without suppression of protonated water and water clusters (proton transfer ionization), with suppression of protonated water and water clusters (charge-exchange ionization), and for comparison electron ionization in a conventional vacuum source;

FIGS. 7A, 7B and 7C display mass spectra of cholesterol as determined with atmospheric pressure ionization with water clusters (proton transfer ionization), with the use of fluorobenzene dopant, and with water cluster suppression and charge-exchange ionization;

FIGS. 8A and 8B display mass spectra of Hexadecane by charge-exchange ionization at two gas temperatures illustrating the temperature effect on fragmentation; and

FIGS. 9A and 9B display two GC/MS chromatograms of a test mix of Grob gas (atmospheric ionization with neutral excited-state species with and without suppression of protonated water clusters).

### DESCRIPTION OF THE PREFERRED EMBODIMENTS

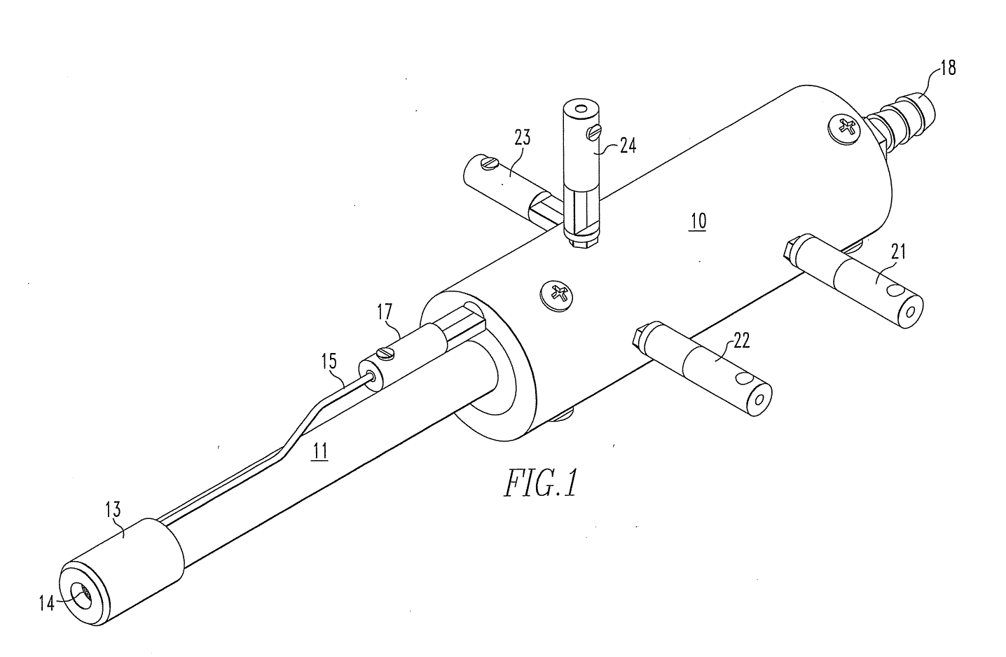

Referring to FIGS. 1 to 3, an apparatus useful for practice of this method invention consists of a tube divided into several chambers through which a gas, such as nitrogen or helium, is allowed to flow. The gas is introduced into a discharge chamber where an electrical potential is applied between a discharge needle at kilovolt potentials and a perforated counter-electrode held at ground potential. A plasma consisting of ions, electrons, and excited-state species is produced in the discharge region. The gas is allowed to flow into an optional second chamber where a second perforated electrode can be biased to remove ions from the gas stream. The gas flow passes through an optional third region that can be optionally heated. Gas exits through an optional third perforated electrode or grid and is directed toward the mass spectrometer sampling orifice. The grid serves two functions: it acts as an ion repeller and it serves to remove charged species of the opposite polarity thereby preventing signal loss by ion-electron recombination. The gas flow can be directed toward a liquid or solid sample or it can interact with vapor-phase samples.

A typical reaction sequence wherein steps are not taken to prevent the formation of charged water clusters is shown below using helium to form the initial excited-state molecules.

1. Formation of excited-state atoms of molecules (e⁻=electron):

He⁰(electrical discharge)→He^{+•}+e⁻

He^{+•}+He^{*}

The He^{*3}S1 state has an energy of 19.8 eV which is above the ionization potential of water of 12.6 eV.

2. Formation of charged water clusters:

He^{*}+H₂O→H₂O^{+•}+He+e⁻

H₂O^{+•}+H₂O→H₃O⁺+OH^{•}

H₃O⁺+(H₂O)ₙ→[(H₂O)ₙH]⁺

3. Reaction of charged water clusters to ionize target analyte molecule M:

[(H₂O)ₙH]⁺+M→[M+H]⁺+(H₂O)ₙ

If helium is used as the carrier gas, the principal excited-state species has an energy of 19.8 eV. This energy is sufficient to ionize most molecules. Under normal conditions, the excited-state helium rapidly reacts with atmospheric moisture to produce positive-ion water clusters or negative-ion clusters containing oxygen and water. The reaction between excited-state helium and water molecules is extremely rapid. Under these conditions, the primary mode of ionization is proton transfer from the ionized water clusters. The largest peaks in the background spectrum are water clusters [(H₂O)ₙH]⁺ formed by interaction of excited-state helium atoms with the sample.

Water has a proton affinity (PA) of 691 kJ/mol. Proton transfer occurs if the sample has a higher proton affinity than the PA of the water clusters. Many compounds are ionized under these conditions. However, some compounds (e.g., alkanes) are not efficiently ionized because they do not have a higher proton affinity than water or water clusters. A compound will only accept a donated proton if it has a higher PA than the donor.

If the conditions are modified to inhibit formation of protonated water clusters, the primary mode of ionization can be changed to a combination of proton transfer and charge exchange from oxygen ions, for example:

O₂^{+•}+Sample->Sample^{+•}O₂

Direct Penning ionization may also occur when protonated water clusters are suppressed as follows:

He*+Sample->Sample^{+•}+electron^{-+He}

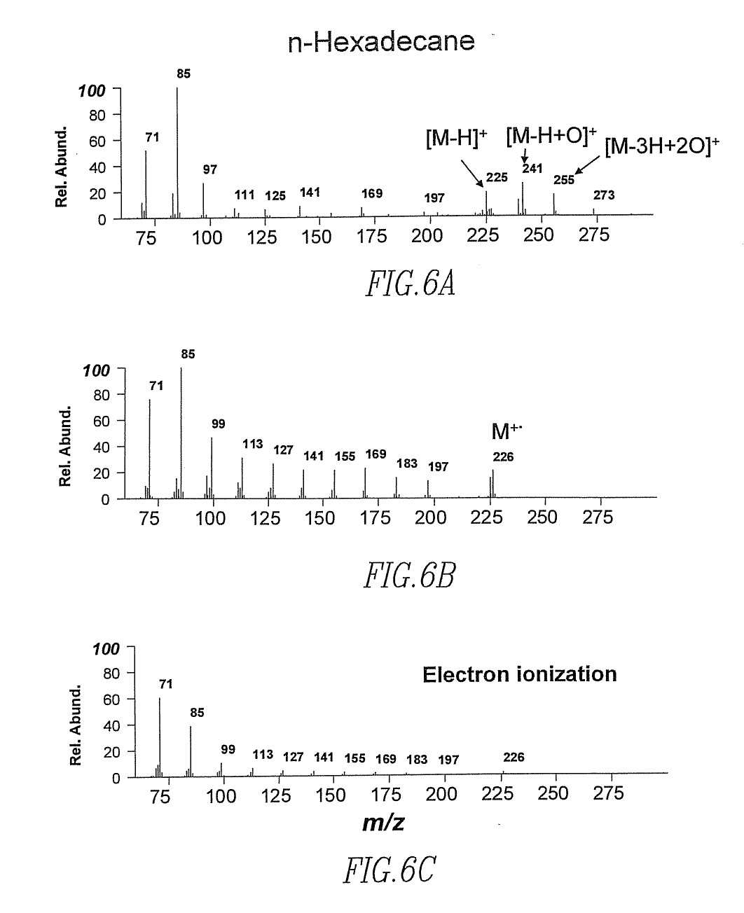

FIGS. 5A and 5B display comparative mass spectra of background ions for atmospheric ionization with neutral excited-state species with and without suppression of protonated water clusters. The major peaks observed under normal conditions are water clusters and ammonium. The major peaks when protonated water clusters are suppressed are water clusters and O₂^{+•}. The relative abundance of O₂^{+•} and [(H₂O)ₙH]⁺ can be varied depending on gas flow, humidity, the exit position of the source of neutral excited-state species relative to the intake orifice of the mass spectrometer, and the potential on the grid at the exit position of the source neutral excited-state species. The small unlabeled peaks in the background of FIG. 5A are the result of solvent vapor (methanol, ethanol, acetone) present in the laboratory air.

The ionization potential (IP) of oxygen (O₂) is 12.07 eV, which is higher than the IP for most common organic compounds including alkanes. For charge-exchange ionization, a compound will only accept a donated electron if it has a lower IP than the donor.

Mass spectra obtained under these conditions for alkanes look very much like electron ionization (EI) mass spectra, including characteristic fragment ions that are used for compound identification by database searching. Molecular ions M^{+•} are observed and [M−H]⁺ may be observed.

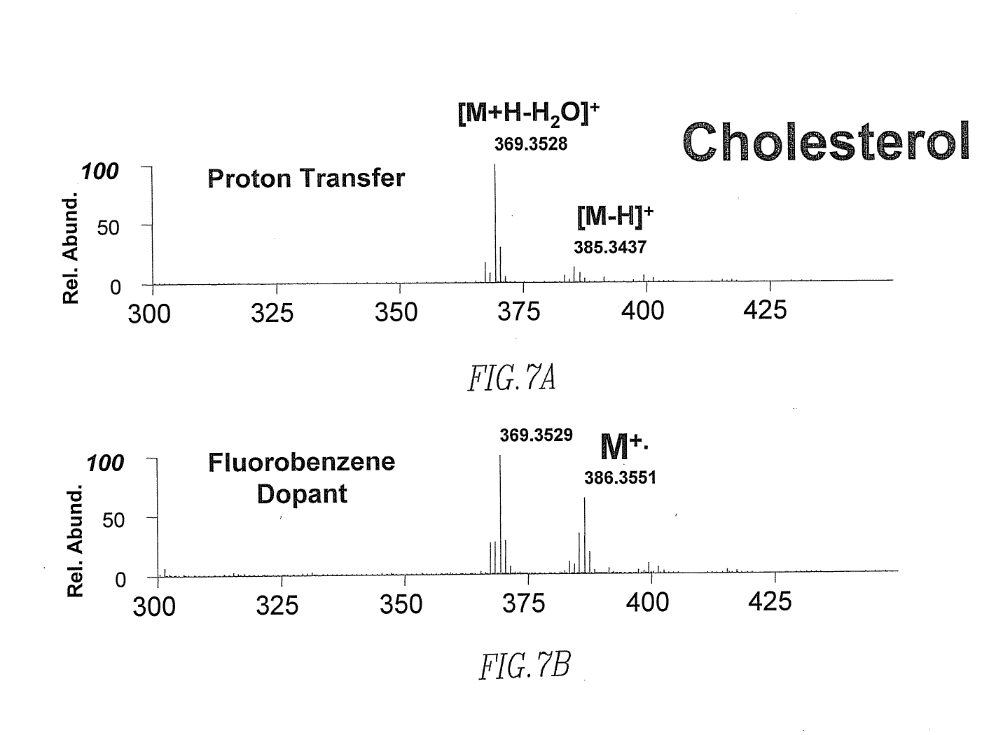

FIGS. 6A, 6B and 6C display mass spectra of n-Hexadecane for atmospheric ionization with neutral excited-state species without suppression of protonated water and water clusters, with suppression of protonated water and water clusters and electron ionization in a conventional vacuum source. The mass spectrum shown in FIG. 6B yields the correct identification of the sample when compared to the databases for EI ionization, whereas a database search on the mass spectrum of FIG. 6A did not.

Aromatic hydrocarbons with electron ionization (EI) uniformly produce molecular ions M^{+•} and proton transfer ions [M+H]⁺. With water cluster ionization at atmospheric pressure, these ions are not always produced. With ionization by charge exchange, from oxygen ions these ions are produced. This mode of ionization has other useful characteristics. The chemical background is reduced making it easier to recognize changes in the ion current when an analyte is present. Furthermore, ion efficiency is more uniform for compounds with different functional groups.

An advantage of the open-air charge-exchange method is that a mass spectrum similar to that obtained by EI can be obtained without the drawback of EI vacuum-based sources. In particular, the electron filaments used in EI are fragile and can break if exposed to air or oxygen while hot. They must be periodically replaced. The open-air charge-exchange method does not require a replaceable filament.

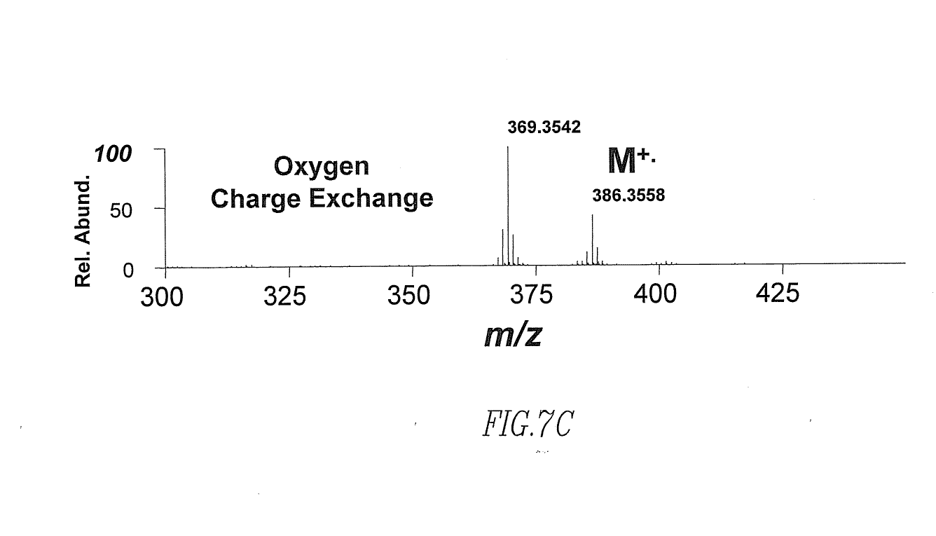

FIGS. 7A, 7B and 7C display mass spectra of cholesterol as determined with atmospheric pressure proton transfer ionization from water clusters; oxygen charge exchange ionization; and fluorobenzene dopant charge-exchange ionization. Charge-exchange ionization has been shown to be effective for producing molecular ions from cholesterol. Fluorobenzene has a proton affinity of 775.9 kJ/mol and an ionization potential of 9.2 eV. Hence, it will react by charge exchange to produce molecular ions as analytes with an IP less than 9.2 eV. Proton transfer, a seen in FIG. 7A, produces an abundant [M+H−H₂O]⁺ peak, but no molecular ion. The charge-exchange method is clearly superior. Fluorobenzene has been used as a dopant for atmospheric pressure photoionization (APPI) with the use of a high-intensity lamp (10 eV). The charge-exchange process, according to the present invention, may be assisted by pulsed photon desorption to produce molecular ions from low-volatility compounds.

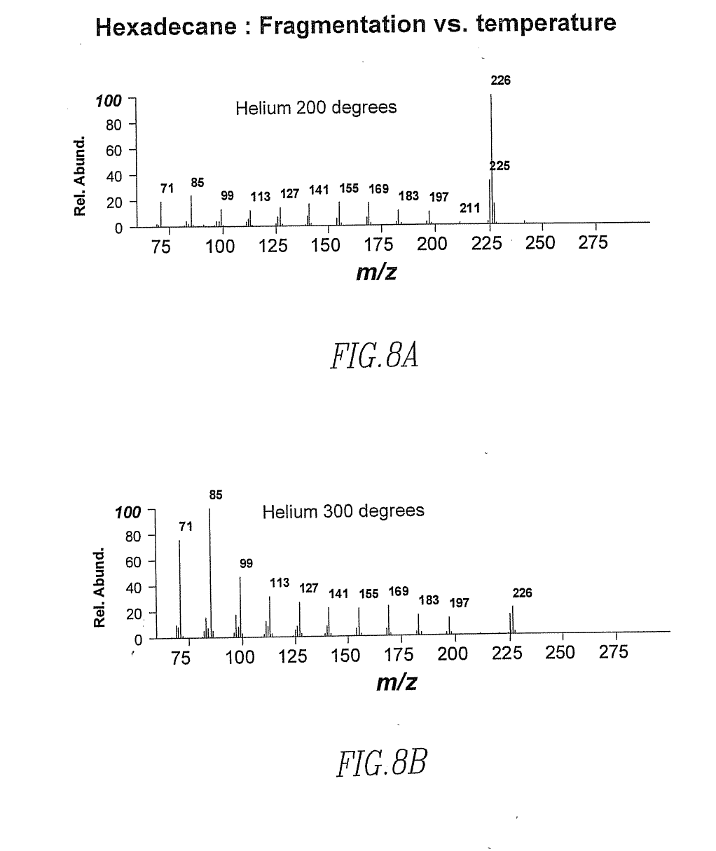

FIGS. 8A and 8B display mass spectra of Hexadecane at two gas temperatures illustrating the temperature effect on fragmentation. The relative abundance of molecules and fragment ions depends on gas temperature. At relatively low temperatures (temperatures required to desorb or vaporize the sample, for example, subambient up to about 200° C.), the molecular ion is abundant and the fragment ions are of low abundance. The relatively high abundance of M^{+•} and [M−H]⁺ makes it easy to identify the molecular weight of the sample. Fragmentation increases with increasing gas temperature with fragment ions becoming dominant at gas temperatures in the range 200° to 300° C. or higher. Under these conditions, the mass spectrum of an n-alkane is virtually identical to a conventional EI mass spectrum with the exception that a [M−H]⁺ peak may be observed. As with EI, the presence of fragments is a “fingerprint” facilitating identification with database searching and often permits distinguishing isometric compounds.

A temperature ramp (programming the carrier gas temperature from low to high in a time-dependent manner) can be used to separate compounds according to their desorption temperature. In this way, an abundant molecular ion can be observed for both high-volatility and low-volatility compounds in a given sample or specimen. This has been demonstrated with a mixture of n-alkanes with carbon numbers from C6 to C44. Abundant molecular ions with minimal fragmentation could be observed for all compounds.

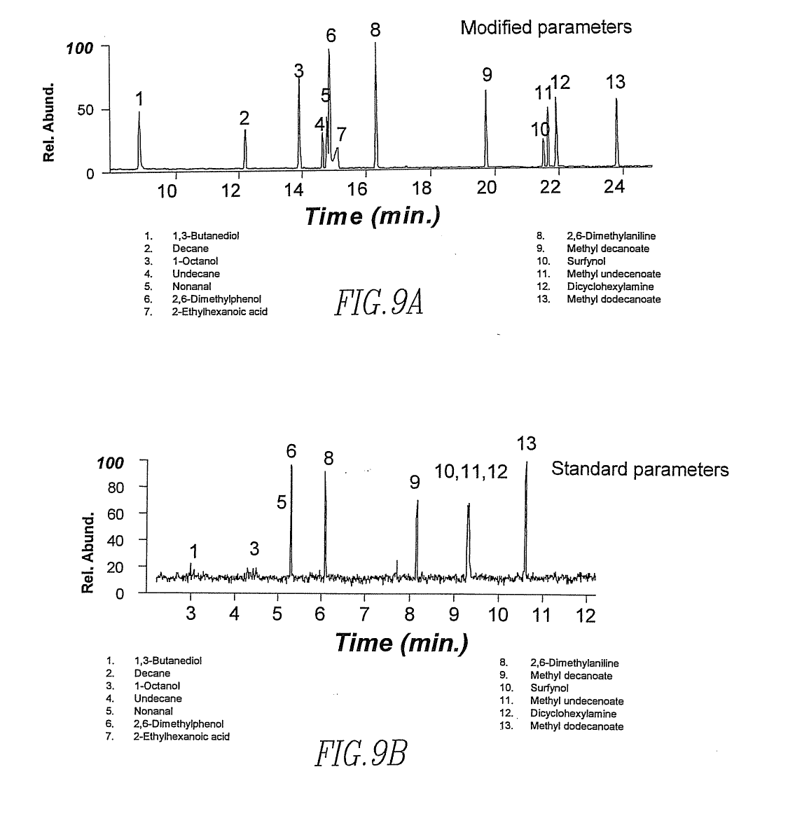

FIGS. 9A and 9B display two GC/MS chromatograms of a test mix of Grob gas. The gas chromatograph column separates the compounds and the MS is used to identify the separated compounds. The output of the chromatograph was directed to the output of the source of excited-state neutral carrier gas. In the case of FIG. 9A, the formation of protonated water clusters was suppressed to promote charge-exchange ionization. In the case of FIG. 9B, it was not. (Note that a slower GC oven temperature program was used for the analysis depicted in FIG. 9A than for FIG. 9B. This will change the retention times of components, but will not affect the elution order signal-to-noise ratio.) Alkanes, e.g., decane and undecane, were not detected when protonated water clusters were not suppressed.

When suppressing the formation of protonated water clusters, a certain amount of NO⁺ (nitric oxide ion) is observed. Nitric oxide is a well-known chemical ionization reagent for chemical ionization of alkanes and aromatic hydrocarbons. The ionization mechanism may be charge-exchange producing M⁺ or hydride-abstraction producing [M−H]⁺ ions. Nitric oxide adducts [M+NO]⁺ can also be observed for aromatic compounds. Nitric oxide chemical ionization can also result in oxidation of the analyte. Other reaction processes can occur when operating with a nitrogen carrier gas to ionize alkanes and aromatics. Oxygen can be incorporated into the molecule, producing abundant oxidized species, such as [M+O−3H]⁺ and [M+O₂−H]⁺ from ionization of alkanes.

The carrier gases that have been used are helium and nitrogen. Any gas or mixture of gases with a metastable state lying higher than a state of the analyte is a potential carrier gas. Both helium and nitrogen have high first electron ionization potentials and are not reactive with other elements or compounds at room temperature and pressure.

The atmospheric-pressure ionization method described herein is useful for the introduction of ions into mass spectrometers and ion mobility spectrometers for the detection and identification of analytes of interest, such as drugs, explosives, chemical weapons, toxic industrial materials and the like. This method is non-radioactive and provides rapid sampling of gas and vapor in headspace sampling. It also permits rapid and direct sampling of chemicals on surfaces.

Referring again to FIG. 1, a physical implementation of an atmospheric-pressure ion device useful, according to the present invention, may comprise a tubular non-conductive casing 10 which may be fabricated from a Teflon®-type plastic (good temperature resistance), glass, a ceramic material or other non-conductive material. Extending from one end of the casing 10 is a disposable glass tube insert 11 with a non-conductive end piece 13 that serves to hold a mesh electrode or grid 14 in place. The mesh electrode 14 is connected by an insulated wire 15 to a micro jack 17 on the casing 10. At the opposite end of the casing 10 is a carrier gas inlet comprising a connector 18 with a corrugated surface for holding a flexible tube slide thereon. Micro jacks 21, 22, 23, and 24 are threaded in the casing for connecting leads from a power supply to the various electrodes within the casing 10.

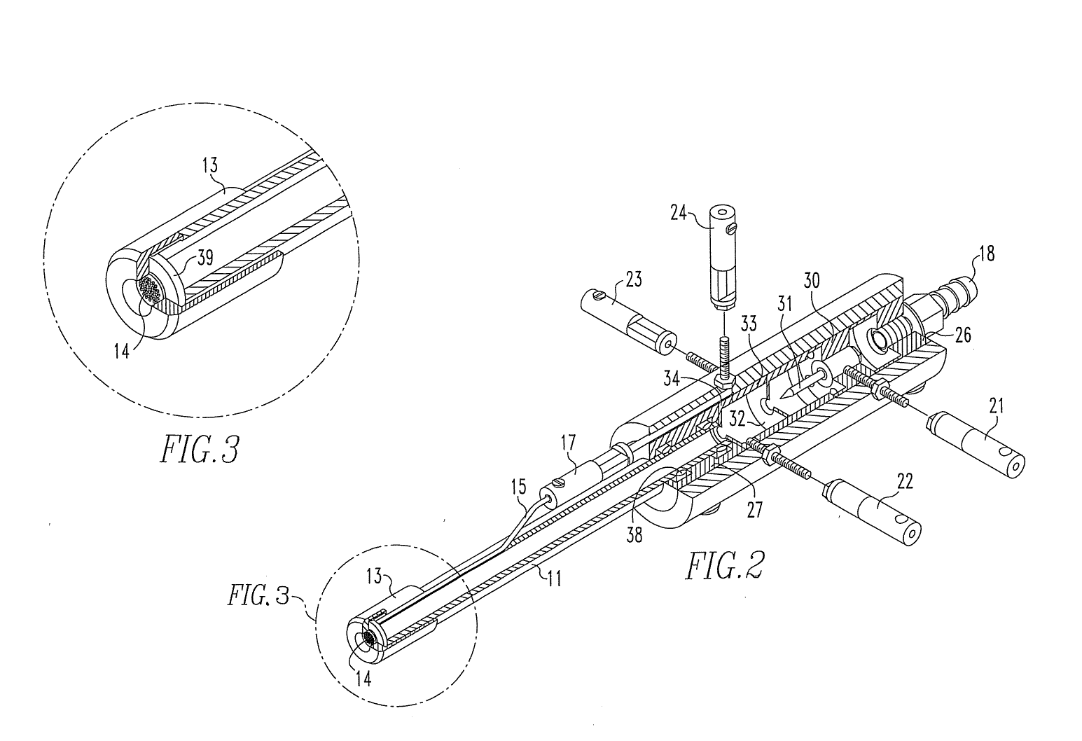

Referring now to FIG. 2, the interior of the casing is divided into first and second chambers. At each axial end, a hollow plug is fixed to the casing. At the inlet end, a plug 26 has threads for receiving the inlet connector 18. At the outlet end, a plug 27 is provided with interior annular grooves for receiving Viton O-rings 38 that seal against the exterior surface of the glass tube insert 11. Non-conductive spacer 30 holds the needle electrode 31 which is connected to micro jack 21 and defines a first chamber in which a corona or glow electrical discharge is created. A conductive spacer and electrode baffle 32 are positioned within the casing and adjacent to the non-conductive spacer supporting the needle. The conductive spacer 32 is connected to micro jack 23. A non-conductive spacer 33 is positioned within the casing and is adjacent to the conductive spacer 32 to define a second chamber. Another conductive spacer and electrode baffle 34 are positioned adjacent to the non-conductive spacer 33 to define the axial outlet end of the second chamber. The conductive spacer 34 abuts the glass tube insert 11. This conductive spacer is connected to micro jack 22. The micro jack 24 is in communication with an electrical conduit that runs axially to the outlet end of the casing where it connects to the micro jack 17.

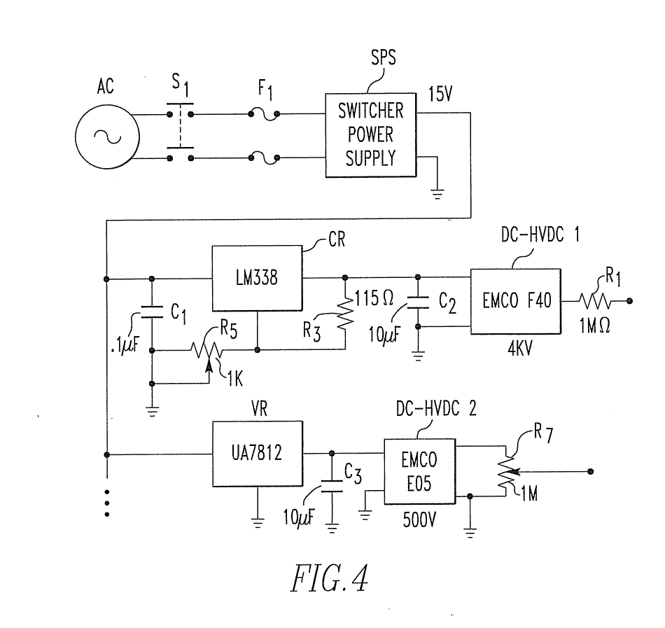

Referring to FIG. 3, the end of the glass tube with the non-conductive end piece 13 is shown in more detail. The non-conductive end piece 13 spaces the grid from direct contact making it difficult to come into contact with the high voltage on the grid. The hole in the end piece allows the escape of the excited-state gas to ionize the analyte. A copper washer 39 abuts the end of the glass tube and is soldered to insulated wire lead 15. Held against the washer is a grid electrode 14. The hollow glass tube 11 and grid electrode 14 define a third chamber.

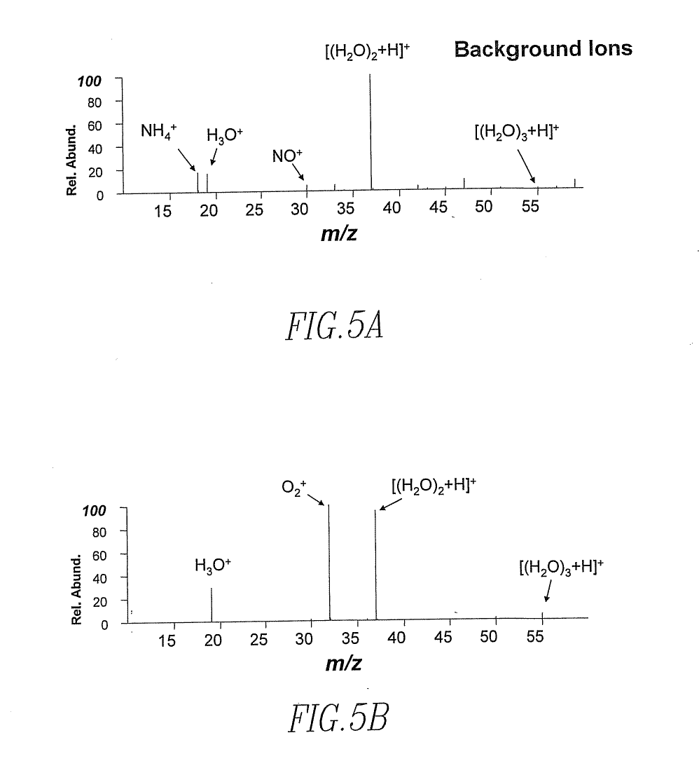

Referring to FIG. 4, an example of a power supply for an atmospheric pressure ion source is shown schematically. AC current passes switch S₁ and fuse F₁ and is applied to switcher power supply SPS. The 15 volt DC output is applied across filter capacitor C₁ to current regulator CR. The regulated current is applied across filter capacitor C₂ to the high-voltage direct current converter DC-HVDC. The high voltage of this device is applied through current limit resistor R₁ to the electrode for creating a corona or glow discharge. The 15 volt output is also applied to a plurality of general purpose, high-current positive voltage regulators VR. The output of the voltage regulators is applied across filter capacitor C₃ to pass current to high-voltage direct converters DC-HVDC₂. The output of the converters is applied to potentiometers R₇ enabling adjustment of the potential on the lens electrodes. Those skilled in power supply design will understand how to configure a circuit for negative output potentials.

The techniques currently found to suppress formation of protonated water and water cluster ions are a) increasing the potential of the exit grid electrode from about 150 V to about 500 to 600 V or greater, b) moving the hole in the end piece of the source to within about 5 mm or less of the inlet port of the mass spectrometer, c) sweeping the sample with desiccated air or oxygen of fluorobenzene or anisole or a suitable dopant, d) heating the apparatus to bake out residual moisture before operating, or e) any combination of these techniques. In the case of GC/MS experiments, the outlet of the GC column or gas transfer line is connected to an extension of the apparatus above described and the outlet port of the extension tube is placed at the sampling orifice of the mass spectrometer atmospheric-pressure interface. The extension tube isolates the carrier gas/neutral excited-state mixture from atmospheric moisture and permits the formation of the reagent ions [O₂^{+•}], for example, formed by leaking trace reagent gases into the loosely-sealed tube. The present invention is not tied to any particular technique for preventing or suppressing the formation of protonated water and water molecules in the vicinity of the sample. Complete suppression is not essential so long as an adequate quantity of charge-exchange ions and/or Penning electrons are formed and directed to the sample.

The atmospheric-pressure ionization method described herein is useful for the introduction of ions into mass spectrometers and ion mobility spectrometers or hybrid ion-mobility spectrometer-mass spectrometer for the detection and identification of analytes of interest, such as drugs, explosives, chemical weapons, toxic industrial materials and the like. It is non-radioactive and provides rapid sampling of gas and vapor in headspace sampling. It also permits rapid and direct sampling of chemicals on surfaces. This feature makes the ion source described herein a very useful replacement for a radioactive source on IMS detectors.

Having thus described my invention in the detail and particularity required by the Patent Laws, what is desired protected by Letters Patent is set forth in the following claims.

What is claimed is:

1. Method of producing analyte, analyte fragment and/or analyte adduct ions for mass spectrographic analysis comprising the steps of:
introducing a carrier gas at atmospheric pressure into a chamber,
adding energy to the chamber creating metastable neutral excited-state species; and
directing the carrier-gas metastable neutral excited-state species mixture into contact with the analyte maintained at atmospheric pressure and near ground potential under conditions that suppress the formation of protonated water clusters.

2. A mass spectrometry method comprising the steps of:
introducing a carrier gas at atmospheric pressure into a chamber;
adding energy to the chamber creating metastable neutral excited-state species;
directing the carrier gas metastable neutral excited-state species mixture into contact with the analyte maintained at atmospheric pressure and near ground potential under conditions that minimize the formation of protonated water clusters to form analyte, analyte fragment and/or analyte adduct ions directly or via an intermediate reactant gas; and
directing analyte, analyte fragment and/or analyte adduct ions into a mass spectrometer.

3. The method according to claim 2, wherein the atmosphere in the vicinity of the analyte is swept with a low-humidity gas.

4. The method according to claim 2, wherein the atmosphere in the vicinity of the analyte is swept with pure oxygen.

5. The method according to claim 3, wherein the analyte is placed within 5 mm of the sampling orifice of the mass spectrometer.

6. The method according to claim 2, wherein a grid beyond the chamber is set to a potential of at least 500 volts.

7. The method according to claim 2, wherein the carrier gas consists substantially entirely of one or more of nitrogen and noble gases with an available metastable state high enough to ionize the analyte directly or via an intermediate reactant gas.

8. The method according to claim 7, wherein the intermediate reactant gas is oxygen.

9. The method according to claim 7, wherein the intermediate reactant gas is nitrogen.

10. The method according to claim 7, wherein the intermediate reactant gas is fluorobenzene.

11. The method according to claim 7, wherein the intermediate reactant gas is anisole.

12. The method according to claim 2, wherein the carrier gas is heated to promote fragmentation as well as formation of molecular ions.

13. The method according to claim 1 or 2, comprising establishing a potential difference in the chamber for adding energy to the carrier gas to create metastable neutral excited-state species.

14. The method according to claim 1 or 2, comprising using photo excitation for adding energy to the carrier gas to create metastable neutral excited-state species.

15. The method according to claim 1 or 2, comprising using microwaves for adding energy to the carrier gas to create metastable neutral excited-state species.
